(19) United States
(12) Patent Application Publication
(10) Pub. No.: US 2010/0288528 A1
(43) Pub. Date: Nov. 18, 2010

(54) COAXIAL CABLES HAVING LOW BOND PRECOAT LAYERS AND METHODS OF MAKING SAME

(75) Inventor: Eddy Houston, Claremont, NC (US)

Correspondence Address: MYERS BIGEL SIBLEY & SAJOVEC, P.O. BOX 37428, RALEIGH, NC, 27612, US

(73) Assignee: CommScope, Inc. of North Carolina

(21) Appl. No.: 12/465,996

(22) Filed: May 14, 2009

(51) Int. Cl. H01B 7/00; H01B 13/016

(52) U.S. Cl. 174/102 R; 29/828

(57) ABSTRACT

A coaxial cable includes an inner conductor, a dielectric layer surrounding the inner conductor, an outer conductor surrounding the dielectric layer, and a precoat layer disposed between the inner conductor and the dielectric layer. The precoat layer is adhesively bonded to the inner conductor and to the dielectric layer, and includes a blend of polymeric material and polymeric wax. The adhesive strength of the precoat layer is reduced by the polymeric wax such that the precoat layer can be removed completely and cleanly from the inner conductor as a result of shear forces applied to the precoat layer by standard commercially available coaxial cable stripping tools.

### FIELD OF THE INVENTION

The present invention relates generally to communications cables and, more particularly, to coaxial cables.

### BACKGROUND

Coaxial cables are a specific type of electrical cable that may be used to carry information signals such as television signals and data signals. Coaxial cables are widely used in cable television networks and to provide broadband Internet connectivity. Coaxial cables are typically constructed of a metallic inner conductor and a metallic sheath “coaxially” surrounding the inner conductor that serves as an outer conductor. A dielectric material surrounds the inner conductor and electrically insulates the inner conductor from the surrounding metallic sheath.

The inner conductors of coaxial cables typically include a precoat layer applied to an outer surface thereof. A precoat layer conventionally is a thin, solid polymer layer that is extruded or applied in liquid emulsions over the surface of the inner conductor of a coaxial cable prior to the application of the subsequent dielectric material. A precoat layer is usually formed from one or more of the following materials: a polyolefin, a polyolefin copolymer adhesive, an anti-corrosion additive and fillers. A precoat layer provides a controlled surface on which subsequently extruded dielectric material can be deposited, and can be used with or without added adhesive components to promote adhesion of dielectric material to an inner conductor in order to reduce movement of the inner conductor in relation to the surrounding insulation. Precoat layers can also be used to reduce or eliminate water migration paths at the dielectric/inner conductor interface.

The preparation of a coaxial cable end for receiving a connector is typically performed by a stripping tool that removes portions of the outer conductor, dielectric layer and precoat to expose a predetermined length of the inner conductor. Conventional stripping tools include cutting edges that exert a combination of rotational and axial shear forces on the cable outer conductor dielectric and precoat layer as the tool is rotated relative to the cable.

Unfortunately, conventional stripping tools may not completely remove the precoat layer from an exposed inner conductor. This is often because, to protect the inner conductor from damage, the blade depths on stripping tools are conventionally positioned so that they do not make contact with the inner conductor surface. As such, the precoat layer typically does not completely shear as the dielectric layer is rotated in a circular motion or break cleanly when the dielectric end portion is removed. Thus, it may be necessary to physically remove precoat remnants, referred to as “tails”, from an exposed inner conductor prior to installation of a connector. Unfortunately, this can be time consuming and costly. Moreover, if the removal of precoat tails is not performed properly, the inner conductor can be damaged, and/or the electrical and/or mechanical performance of the cable may be compromised.

### SUMMARY

In view of the above discussion, improved coaxial cables and methods of making same are provided. According to some embodiments of the present invention, a coaxial cable includes an inner conductor, a dielectric layer surrounding the inner conductor, an outer conductor surrounding the dielectric layer, and a precoat layer disposed between the inner conductor and the dielectric layer. The precoat layer is adhesively bonded to the inner conductor and to the dielectric layer. The precoat layer is a blend of polymeric material and polymeric wax. The polymeric wax reduces the adhesive strength of the precoat layer such that the precoat layer can be removed completely and cleanly from the inner conductor as a result of shear forces applied to the precoat layer by a standard commercially available coaxial cable stripping tool. In some embodiments, the precoat layer is a blend of low density polyethylene (LDPE) and polyethylene (PE) wax, The PE wax constitutes less than or equal to about 15% by weight of the blend. In some embodiments, the PE wax constitutes less than or equal to about 10% by weight of the blend, and in some embodiments the PE wax constitutes between about 2% and 10% by weight of the blend. The precoat layer may additionally include one or more of filler materials and/or anti-corrosion additives.

A method of manufacturing a coaxial cable, according to some embodiments of the present invention, includes directing a conductor along a predetermined path of travel into and through a preheater and preheating the conductor. A thermoplastic polymer precoat composition comprising a blend of low density polyethylene (LDPE) and polyethylene (PE) wax is melted in the first extruder. The PE wax constitutes less than or equal to about 15% by weight of the blend. In some embodiments, the PE wax constitutes less than or equal to about 10% by weight of the blend, and in some embodiments, the PE wax constitutes between about 2% and 10% by weight of the blend. The precoat layer may additionally include one or more of filler materials and/or anti-corrosion additives.

The preheated conductor is directed into and through the first extruder and a continuous thin coating layer of the molten precoat composition is extruded onto the surface of the center conductor. The layer of precoat composition is allowed to cool and solidify, and then the conductor and layer of precoat composition thereon are directed into and through a second extruder where a foamable polymer composition is extruded onto the coated conductor. The foamable polymer composition is allowed to expand, cool and solidify to form a foam dielectric surrounding the conductor. A continuous metallic sheath forming an outer conductor of the coaxial cable is applied so as to surround the foam dielectric.

Other coaxial cables and methods of making same according to exemplary embodiments will be or become apparent to one with skill in the art upon review of the following drawings and detailed description. It is intended that all such additional cables and methods be included within this description, be within the scope of the present invention, and be protected by the accompanying claims.

### BRIEF DESCRIPTION OF THE DRAWINGS

FIG. 1 is a cutaway perspective view of a coaxial cable in which a precoat layer that includes polymeric wax, according to embodiments of the present invention, may be utilized.

FIGS. 2A and 2B schematically illustrate a method of making a coaxial cable having a precoat layer with polymeric wax, according to embodiments of the present invention.

FIG. 3 is a cutaway perspective view of a coaxial cable in which a precoat layer that includes polymeric wax, according to embodiments of the present invention, may be utilized.

FIGS. 4A and 4B schematically illustrate a method of making a coaxial cable having a precoat layer with polymeric wax, according to embodiments of the present invention.

FIGS. 5-9 are graphs illustrating experimental data for coaxial cables in which precoat layers with polymeric wax, according to embodiments of the present invention, have been utilized.

### DETAILED DESCRIPTION

The present invention now is described more fully hereinafter with reference to the accompanying drawings, in which some embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning is in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present.

It will be understood that, although the terms “first”, “second”, etc. may be used herein to describe various elements, components, etc., these elements, components, etc. should not be limited by these terms. These terms are only used to distinguish one element, component, etc. from another element, component, etc. Thus, a “first” element or component discussed below could also be termed a “second” element or component without departing from the teachings of the present invention. In addition, the sequence of operations (or steps) is not limited to the order presented in the claims unless specifically indicated otherwise.

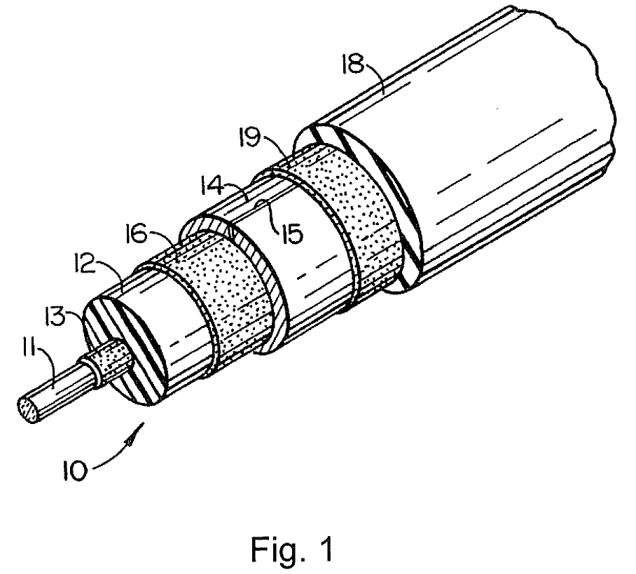

FIG. 1 illustrates a coaxial cable 10 in which embodiments of the present invention may be implemented. The illustrated cable 10 has an inner conductor 11 of a suitable electrically conductive material and a surrounding dielectric layer 12. The inner conductor 11 is formed of conductive material such as copper, copper-clad aluminum, copper-clad steel, aluminum, etc. However, other conductive materials may be utilized. In addition, as illustrated in FIG. 1, the inner conductor 11 is typically a solid conductor. In the embodiment illustrated in FIG. 1, only a single conductor 11 is shown, located coaxially in the center of the cable, as this is the most common arrangement for coaxial cables of the type used for transmitting RF signals. However, embodiments of the present invention may be utilized on other types of cables having multiple inner conductors.

Still referring to FIG. 1, the dielectric layer 12 surrounds the inner conductor 11, and is typically a low loss dielectric formed of a suitable plastic such as polyethylene, polypropylene, polystyrene, etc. In some embodiments, the dielectric material may be an expanded cellular foam composition. For example, the dielectric layer 12 may be a continuous cylindrical wall of expanded foam plastic dielectric material such as a foamed polyethylene, etc.

A thin polymeric precoat layer 13 surrounds the inner conductor 11 and adheres the inner conductor to the surrounding dielectric layer 12. The precoat layer 13 typically has a thickness of from 0.0001 to 0.020 inches, typically from 0.0005 to 0.010 inches, and most typically from 0.005 to 0.010 inches; however, other thicknesses are possible.

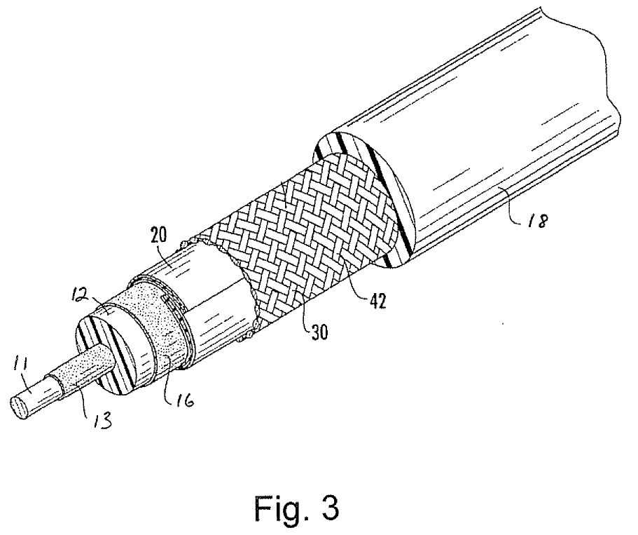

Closely surrounding the dielectric layer 12 is an outer conductor 14. In the embodiment illustrated in FIG. 1, the outer conductor 14 is a solid or laminated metallic sheath. The outer conductor 14 is formed of a suitable electrically conductive metal, such as aluminum, an aluminum alloy, copper, a copper alloy, etc. In the case of trunk and distribution cable, the outer conductor 14 is both mechanically and electrically continuous to allow the outer conductor 14 to mechanically and electrically seal the cable from outside influences as well as to prevent the leakage of RF radiation. The outer conductor 14 can be perforated to allow controlled leakage of RF energy for certain specialized radiating cable applications. As described below with respect to FIG. 3, for drop cables, an outer shield may consist of a laminated aluminum or copper tape with a metallic braid of similar materials.

In the embodiment illustrated in FIG. 1, the outer conductor 14 is made from a metallic strip that is formed into a tubular configuration with the opposing side edges butted together, and with the butted edges continuously joined by a continuous longitudinal weld, indicated at 15. While production of the outer conductor 14 by longitudinal welding has been illustrated for this embodiment, persons skilled in the art will recognize that other known methods could be employed such as extruding a seamless tubular metallic sheath or combination of laminated or solid shielding tapes and braid combinations.

The inner surface of the outer conductor 14 is preferably continuously bonded throughout its length and throughout its circumferential extent to the outer surface of the dielectric layer 12 by a thin layer of adhesive 16. A protective jacket 18 surrounds the outer conductor 14 and may be adhesively bonded thereto via a layer of adhesive 19. The jacket 18 is configured to protect the cable 10 from moisture and other environmental effects. Suitable compositions for the outer protective jacket 18 include, but are not limited to, thermoplastic coating materials such as polyethylene, polyvinyl chloride, polyurethane and rubber.

FIG. 3 illustrates another type of coaxial cable 10 in which embodiments of the present invention may be implemented. The illustrated cable 10 in FIG. 3 has an inner conductor 11 of a suitable electrically conductive material and a surrounding dielectric layer 12. The inner conductor 11 is formed of conductive material such as copper, copper-clad aluminum, copper-clad steel, aluminum, etc. However, other conductive materials may be utilized. An electrically conductive shield 20 (e.g., laminated aluminum or copper tape, etc.) surrounds the dielectric layer 12 and is bonded to the dielectric layer 12 via a layer of adhesive 16. A braid 42 of one or more types of elongate wires 30 surround the conductive shield 20. A cable jacket 18 surrounds the braid 42 and protects the cable 10 from moisture and other environmental effects.

Although two types of coaxial cables are illustrated in FIGS. 1 and 3, embodiments of the present invention are not limited to any particular coaxial cable construction.

According to embodiments of the present invention, the precoat layer 13 in each of the embodiments of FIGS. 1 and 3 is formed from a mixture of polymeric material, such as low density polyethylene (LDPE) and a polymeric wax, such as polyethylene (PE) wax. The wax may have a concentration level of up to about 15% by weight of the mixture. Preferably, the polymeric wax has a concentration level of between about 2% and 10% by weight of the mixture. Other polymers that may be used include, but are not limited to linear low density polyethylene (LLDPE), medium density polyethylene (MDPE), high density polyethylene (HDPE), and ethylene acrylic acid/ethylene vinyl acetate (EAA/EVA) copolymers.

An exemplary LDPE is Equistar NA270, available from Equistar Chemicals, Rotterdam, The Netherlands. An exemplary PE wax is Akrowax PE-100, available from Akrochem Corporation, Akron, Ohio. Akrowax PE-100 has a melting point between 95°-100° C. Preferably, the LDPE has a very high melt index (e.g., 70-80 gm/10 minute), a low tensile strength (e.g., approximately 1200 psi), and lower than average elongation. Additional filler materials may be added, such as a copper corrosion inhibitor. An exemplary copper corrosion inhibitor is benzotriazole (BTA). Because LDPE has ample self-adhesion properties, i.e., good chain branching, no additional adhesive may be required.

Applicants have unexpectedly discovered that the inclusion of a PE wax into a polymer precoat layer, such as LDPE, reduces the post-cooling adhesion of the precoat layer as it reaches equilibrium after cable manufacturing (e.g., after braiding, jacketing, and field aging). For example, Applicants discovered that post extrusion adhesion of a precoat layer can be reduced between about 10%-30% as a result of the inclusion of PE wax at concentration levels of up to about 15% by weight. As a result, there is lower bond strength between the dielectric layer 12 and the inner conductor 11. Because of the reduced adhesion, a precoat layer can be removed completely and cleanly from the inner conductor 11, and without leaving fuzzy residue or tails, as a result of the shear forces applied to the precoat layer 13 by both manual and automated stripping tools. Moreover, Applicants discovered that it is possible to strip sections of a dielectric layer 12 away from an inner conductor 11 that are up to three inches in length with no residual precoat remaining on the inner conductor 11.

Applicants have also discovered that the use of PE wax in concentrations levels up to about 15% by weight in a precoat layer does not have any immediate or long term impact on the electrical or attenuation properties of a coaxial cable. Moreover, the PE wax does not negatively affect cable performance requirements, such as water migration (dye) or air transmission along the precoat/conductor interface.

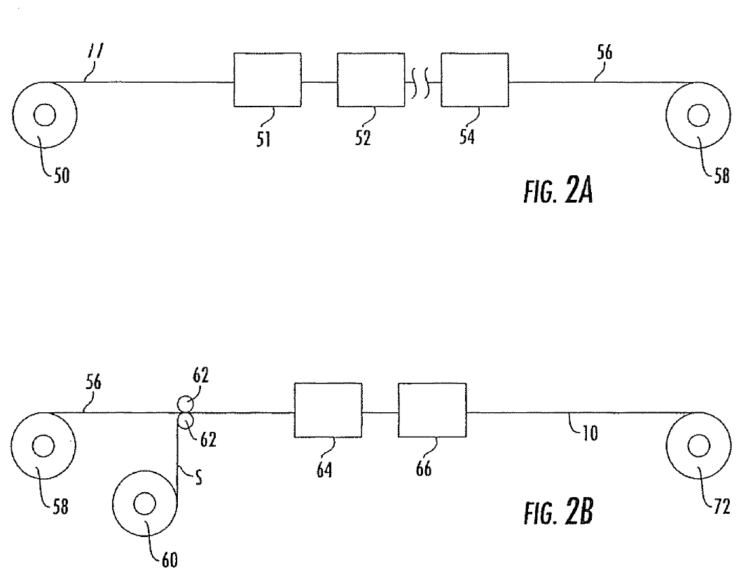

FIGS. 2A and 2B illustrate a method of making the coaxial cable 10 of FIG. 1 with a precoat layer having lower adhesion, according to some embodiments of the present invention. As illustrated in FIG. 2A, an inner conductor 11 is directed from a suitable supply source, such as a reel 50, along a predetermined path of travel (from left to right in FIG. 2A). The inner conductor 11 is preferably advanced first through a preheater 51, which heats the conductor to an elevated temperature to remove moisture or other contaminants on the surface of the conductor and to prepare the conductor for receiving the precoat layer 13. The preheated conductor then passes through a cross-head extruder 52, where a polymeric material/wax blend having a wax concentration of up to about 15% by weight is extruded onto the surface of conductor 11.

The precoat layer 13 is allowed to cool and solidify prior to being directed through a second extruder apparatus 54 that continuously applies a foamable polymer composition concentrically around the coated inner conductor. Preferably, high-density polyethylene and low-density polyethylene are combined with nucleating agents in the extruder apparatus 54 to form the polymer melt. Upon leaving the extruder 54, the foamable polymer composition foams and expands to form a dielectric layer 12 around the inner conductor 11.

In addition to the foamable polymer composition, an adhesive composition may be coextruded with the foamable polymer composition around the foam dielectric layer 12 to form adhesive layer 16. Extruder apparatus 54 continuously extrudes the adhesive composition concentrically around the polymer melt to form an adhesive coated core 56. Although coextrusion of the adhesive composition with the foamable polymer composition is preferred, other suitable methods such as spraying, immersion, or extrusion in a separate apparatus can also be used to apply the adhesive layer 16 to the dielectric layer 12 to form the adhesive coated core 56. Alternatively, the adhesive layer 16 can be provided on the inner surface of the outer conductor 14.

After leaving the extruder apparatus 54, the core 56 is preferably cooled and then collected on a suitable container, such as reel 58, prior to being advanced to the manufacturing process illustrated in FIG. 2B. Alternatively, the core 56 can be continuously advanced to the manufacturing process of FIG. 2B without being collected on a reel 58.

As illustrated in FIG. 2B, the adhesive coated core 56 can be drawn from reel 58 and further processed to form the coaxial cable 10. A narrow elongate strip S, preferably formed of aluminum, from a suitable supply source such as reel 601 is directed around the advancing core 56 and bent into a generally cylindrical form by guide rolls 62 so as to loosely encircle the core to form a tubular sheath 14. Opposing longitudinal edges of the strip S can then be moved into abutting relation and the strip advanced through a welding apparatus 64 that forms a longitudinal weld 15 by joining the abutting edges of the strip S to form an electrically and mechanically continuous sheath 14 loosely surrounding the core 56. Once the sheath 14 is longitudinally welded, the sheath 14 can be formed into an oval configuration and weld flash scarfed from the sheath 14 as set forth, for example, in U.S. Pat. No. 5,959,245. Alternatively, or after the scarfing process, the core 56 and surrounding sheath 14 advance directly through at least one sinking die 66 that sinks the sheath 14 onto the core 56, thereby causing compression of the dielectric 12. A lubricant may be applied to the surface of the sheath 14 as it advances through the sinking die 66. An optional outer polymer jacket 18 can then be extruded over the sheath 14. The thus produced cable 10 can then be collected on a suitable container, such as a reel 72, for storage and shipment.

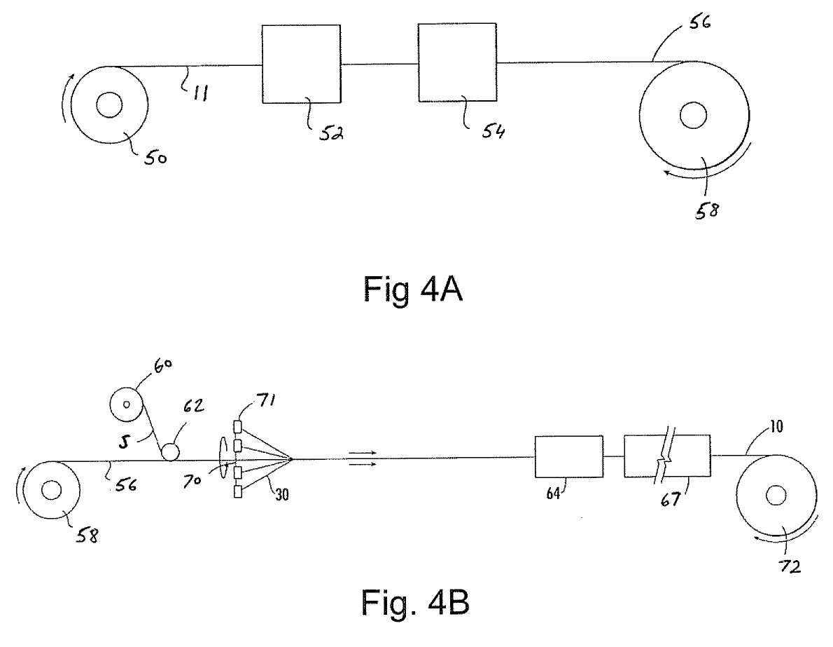

FIGS. 4A-4B illustrate a method of making the coaxial cable 10 of FIG. 3 with a precoat layer having lower adhesion, according to some embodiments of the present invention. As illustrated in FIG. 4A, a center conductor 11 is advanced from a reel 44 along a predetermined paths of travel. As the center conductor 11 advances, a precoat layer 13 is applied by a suitable apparatus 52 such as an extruder apparatus. The adhesive-coated center conductor then further advances to an extruder apparatus 54 that applies a polymer melt composition to the center conductor 11, thereby activating the adhesive, layer 13. Once the coated center conductor leaves the extruder apparatus 54, the polymer melt composition expands to form the dielectric layer 12. The resulting cable core 56 can then be collected on a reel 58 or further advanced through the manufacturing process.

As shown in FIG. 4B, the cable core 56 comprising a center conductor 11 and surrounding dielectric layer 12 is advanced from a reel 58. As the cable core 56 is advanced, a shielding tape S is supplied from a reel 60 and is longitudinally wrapped around the cable core 56 to form an electrically conductive shield 20. The shielding tape S may be a bonded metal-polymer-metal laminate tape having an adhesive on one surface thereof. The shielding tape S is applied with the adhesive surface positioned adjacent the underlying cable core 56. If an adhesive layer is not already included on the shielding tape S, an adhesive layer can be applied by suitable means such as extrusion prior to longitudinally wrapping the shielding tape S around the core 56. One or more guiding rolls 62 direct the shielding tape S around the cable core 56 with longitudinal edges of the first shielding tape preferably overlapping to provide a conductive shield 20 having 100% shielding coverage of the cable core 56.

The wrapped cable core 56 is next advanced to a creel 70 that helically winds or “serves” one or more types of elongate wires 30 around the conductive shield 20 to form a braid 42. The creel 70 preferably includes a plurality of spools 71 for arranging the elongate wires 30 around the conductive shield 20. The creel 70 rotates in either a clockwise or counterclockwise direction to provide helical winding of the elongate wires 30.

Once the elongate wires 30 have been applied, the cable is advanced to an extruder apparatus 64 and a polymer melt is extruded at an elevated temperature around the elongate strands to form the outer cable jacket 18. Once the protective jacket 18 has been applied, the cable is quenched in a cooling trough 67 to harden the jacket 18 and the cable is taken up on a reel 72.

### Experimental Results

A sample of Akrowax PE-100 having a melting point between 95-100° C. was secured from Akrochem Corporation and hot blended with 20 pounds of Equistar NA270 natural LDPE at a 75/25 (NA270/PE-100) ratio under the product code CL BX3143A (CLEAR 1624).

The CL BX3143A master batch was then mixed with the NA594 legacy precoat at various concentrations to determine the impact of the wax concentration on post extrusion (hot/cold) bond performance. F6 sized product was used for all process trials along with copper clad 0.0403″ steel inner conductor. The initial trial matrix consisted of the compositions shown in Table 1 as follows:

TABLE 1
Sample Matrix and PPM of Wax Component

| | | % Master | % | Wax |
|---|---|---|---|---|
| Condition | % NA 594 | batch | WAX | (PPM) |
| Trial 1 | 80 | 20 | 5 | 50,000 |
| Trial 2 | 90 | 10 | 2.5 | 25,000 |
| Trial 3 | 95 | 5 | 1.25 | 12,500 |
| Trial 4 | 60 | 40 | 10 | 100,000 |

Following the trial, a series of bond tests conducted per ANSI/SCTE 59-2002 was implemented at defined intervals following post extrusion of the primary and jacket sequence. Since the addition of the jacket has historically shown to impact the bond performance, PVC more so than polyethylene jackets, the decision was made to primarily benchmark the bond performance using post-jacketing data. All samples including the control were run with FR compound and on F677TS constructions to eliminate any bias with the manufacturing and sample preparation techniques. Attenuation measurements were conducted on the sample containing the highest concentration of the PE Wax/master batch and compared to a control sample run under similar conditions. The attenuation samples were then heat aged for eight weeks at 170° F. to determine if the electrical stability of the modified precoat had any negative impact on the cable's ability to meet the established SCTE and Satellite cable specifications. In addition, salt fog tests were conducted in accordance with ANSI/SCTE 69-2009 to determine the impact of adding the non-BTA stabilized master batch to the NA594 base compound. All bond aging conditions occurred at 20° C. under laboratory conditions.

### Data and Results

### 1) Bond/Prep Performance:

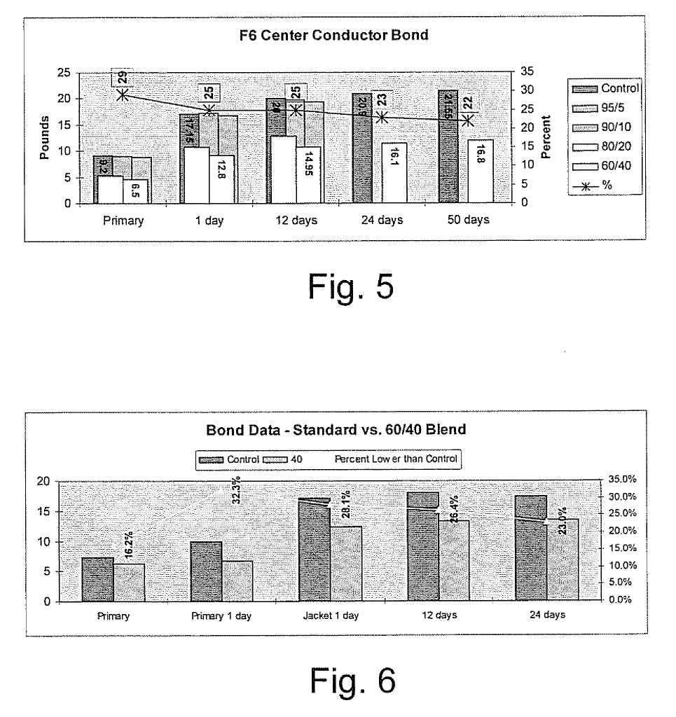

The initial bond study gave immediate correlation between the PE Wax concentration and post cooling inner conductor bond performance. The bond performance for the blend having the highest concentration, approximately 10%, showed bond values that ranged from 29% lower at primary to 25%-22% over a 50 day period after jacketing. (See FIG. 5).

The optimal reduction in post “cooling” bond performance was gained when using a higher concentration, approximately 10%, of the PE wax. Furthermore, the 60/40 blend with 10% wax also showed significant improvement in stripability as was observed during the sample preparation for the bond tests specimens. The modified precoat material, while still showing adequate inner conductor bond, appears to break cleanly during the rotational stresses applied to the dielectric when using a standard prep tool. These results were consistent when using the standard ¼″×¼″ cable prep process. However, to simulate extreme stripping conditions, it was possible to remove sections of the jacket and braided core in lengths up to three inches with no residual precoat “fuzz” or tails. When rotating the cut section, a small audible snap can be detected indicating that the section of cable can be removed from the inner conductor.

Based on the observations made in trial one (see FIG. 5), a decision was made to replicate the process trial using only the 60/40 blend (Note: During the initial waiting period between Trial 1 and Trial 2, a small trial was run with a 50/50 blend; however, those results did not show any significant reduction in bond performance over the 60140 blend). Again bond tests were made at the initial primary stage and after jacketing and then under aged conditions. The results summarized in FIG. 6 show that the bond remains 23% to 28% lower than the control group after jacket and aged conditions, which support the initial findings observed during Trial #1.

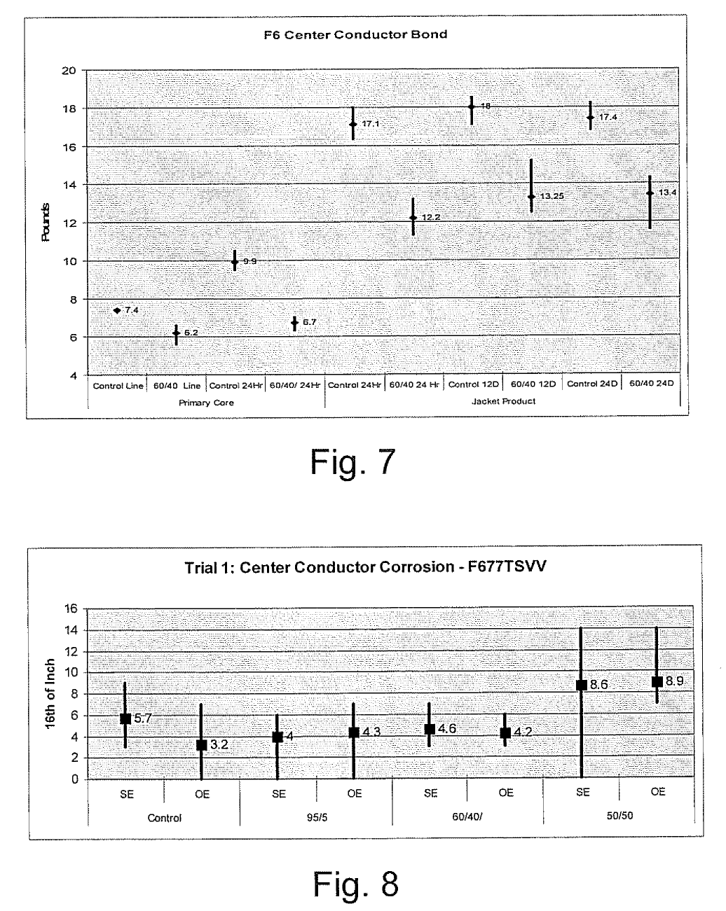

The graph in FIG. 7 provides a different angle for the data presented in FIG. 6. Instead of looking at average bond for a subset of specimens, the chart shows the range of performance over the sampling set comparing the 60/40 to standard drop precoat over the range of aging conditions. In understanding the problems in the field, it is often not the average bond that affects automated stripping and prepping process but bond outliers wherein bond values on short jumpers swing to extreme high or low bond (short jumpers) values within a given reel or production lot.

### 2) Corrosion Performance:

Salt fog corrosion was conducted per the SCTE requirements for a minimum of 144 hours. Given that the masterbatch does not contain any BTA additives, the addition of the target level of masterbatch will reduce the total BTA composition in the overall precoat by that percent. For example, 60/40% contains only 60% of the BTA compared to the “control” sample manufactured with straight NA594. FIG. 8 shows the results from Trial #1 with the addition of the results from the 50/50 trial that was run in background of the original primary trials. As shown, it appears that at a level of 50%, the corrosion protection of the inner conductor could be greatly compromised.

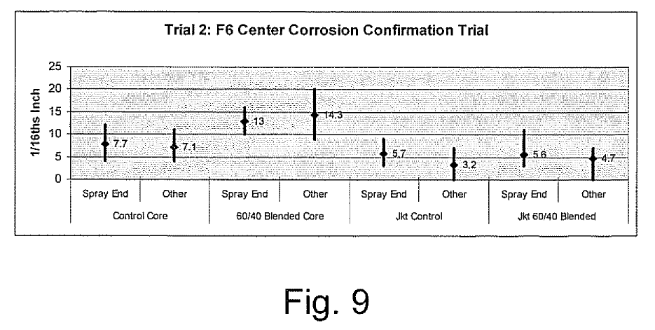

FIG. 9 summarizes the salt fog corrosion performance based on the secondary replication trial with the target 60/40 blend. Note that there are some differences in salt fog corrosion performance between primary core and jacket cable but the performance gap is much smaller using jacketed samples.

### 3) Electrical Characteristics:

Attenuation measurements were made on Trial #1 product containing the 60/40 precoat blend. The cable was stabilized in the lab for 24 hours and then heat aged for four and eight weeks to determine if the electrical stability remained consistent with historical performance as well as meeting the attenuation requirements published by SCTE and internal product specification sheets.

TABLE 2
Results of Heat Aging for Attenuation of 60/40 Blend from Trial 1

| Frequency | | | | dB | | |
|---|---|---|---|---|---|---|
| (MHz) | Stabilized | 4 wks | 8 wks | Change | Control | Specification |
| 5 | 1.70 | 1.75 | 1.73 | 0.03 | 1.71 | 1.90 |
| 55 | 4.86 | 1.90 | 4.96 | 0.10 | 4.84 | 5.25 |
| 83 | 5.86 | 5.84 | 5.87 | 0.01 | 5.79 | 6.40 |
| 187 | 8.37 | 8.44 | 8.51 | 0.14 | 8.31 | 9.35 |
| 211 | 8.86 | 8.90 | 8.99 | 0.13 | 8.80 | 10.01 |
| 250 | 9.63 | 9.67 | 9.78 | 0.15 | 9.58 | 10.83 |
| 300 | 10.53 | 10.56 | 10.67 | 0.14 | 10.51 | 11.65 |
| 350 | 11.39 | 11.44 | 11.57 | 0.18 | 11.39 | 12.63 |
| 400 | 12.20 | 12.26 | 12.40 | 0.20 | 12.21 | 13.62 |
| 450 | 12.98 | 13.05 | 13.20 | 0.22 | 12.99 | 14.44 |
| 500 | 13.72 | 13.78 | 13.95 | 0.23 | 13.74 | 15.29 |
| 550 | 14.42 | 14.50 | 14.67 | 0.25 | 14.45 | 16.08 |
| 600 | 15.10 | 15.18 | 15.36 | 0.26 | 15.13 | 16.73 |
| 750 | 16.97 | 17.07 | 17.28 | 0.31 | 17.00 | 18.54 |
| 865 | 18.29 | 18.40 | 18.62 | 0.33 | 18.33 | 20.01 |
| 1000 | 19.74 | 19.86 | 20.10 | 0.36 | 19.77 | 21.49 |
| 1250 | 22.22 | 22.36 | 22.60 | 0.38 | 22.23 | 24.00 |
| 1450 | 24.06 | 24.21 | 24.50 | 0.44 | 24.05 | 25.82 |
| 1500 | 24.52 | 24.67 | 24.98 | 0.46 | 24.50 | 26.51 |
| 1750 | 26.68 | 26.73 | 27.11 | 0.43 | 26.60 | 28.37 |
| 1800 | 27.06 | 27.13 | 27.50 | 0.44 | 27.00 | 28.77 |
| 2000 | 28.55 | 28.62 | 29.05 | 0.50 | 28.53 | 30.30 |
| 2200 | 30.00 | 30.11 | 30.56 | 0.56 | 30.05 | 31.75 |
| 2250 | 30.38 | 30.47 | 30.92 | 0.54 | 30.39 | 32.11 |
| 2500 | 32.14 | 32.24 | 32.71 | 0.57 | 32.17 | 33.82 |
| 3000 | 35.48 | 35.54 | 36.20 | 0.72 | 35.58 | 37.01 |

The results show little change in attenuation following eight weeks of aging. Overall both the test and control values fell well below the historical attenuation performance and established specifications for F6 products.

Table 3 below provides a summary of additional attenuation studies that are currently underway on samples of the 60/40 blend manufactured during Trial #2. Due to some slight increases in attenuation observed during the initial heat aging study, both 60/40 and control samples are being run parallel to determine if any increase in attenuation is realized. Based on the initial stabilized attenuation measurements, the 60/40 product is performing well below established specifications.

TABLE 3
Summary of Attenuation from Replication Trial - 60/40 Blend

| | Type | | | | |
|---|---|---|---|---|---|
| | 60-40 Blend | | Control | | |
| | Reel | Reel | Reel | Reel | |
| Frequency (MHz) | 208 | 209 | 212 | 213 | Specification |
| 5 | 1.65 | 1.64 | 1.70 | 1.69 | 1.90 |
| 55 | 4.68 | 4.69 | 4.70 | 4.70 | 5.25 |
| 83 | 5.61 | 5.62 | 5.66 | 5.66 | 6.40 |
| 187 | 8.20 | 8.21 | 8.27 | 8.26 | 9.35 |
| 211 | 8.72 | 8.73 | 8.77 | 8.77 | 10.01 |
| 250 | 9.51 | 9.52 | 9.56 | 9.55 | 10.83 |
| 300 | 10.46 | 10.47 | 10.49 | 10.48 | 11.65 |
| 350 | 11.35 | 11.36 | 11.37 | 11.36 | 12.63 |
| 400 | 12.18 | 12.20 | 12.21 | 12.18 | 13.62 |
| 450 | 12.96 | 12.99 | 12.99 | 12.97 | 14.44 |
| 500 | 13.70 | 13.74 | 13.73 | 13.71 | 15.29 |
| 550 | 14.42 | 14.46 | 14.44 | 14.42 | 16.08 |
| 600 | 15.10 | 15.14 | 15.12 | 15.10 | 16.73 |
| 750 | 16.98 | 17.01 | 17.00 | 16.98 | 18.54 |
| 865 | 18.31 | 18.33 | 18.32 | 18.30 | 20.01 |
| 1000 | 19.76 | 19.78 | 19.76 | 19.74 | 21.49 |
| 1250 | 22.24 | 22.25 | 22.22 | 22.21 | 24.00 |
| 1450 | 24.08 | 24.09 | 24.06 | 24.04 | 25.82 |
| 1500 | 24.53 | 24.55 | 24.51 | 24.48 | 26.51 |
| 1750 | 26.65 | 26.67 | 26.61 | 26.59 | 28.37 |
| 1800 | 27.04 | 27.07 | 27.01 | 27.01 | 28.77 |
| 2000 | 28.59 | 28.62 | 28.54 | 28.51 | 30.30 |
| 2200 | 30.12 | 30.15 | 30.06 | 30.03 | 31.75 |
| 2250 | 30.49 | 30.50 | 30.42 | 30.38 | 32.11 |
| 2500 | 32.29 | 32.31 | 32.20 | 32.21 | 33.82 |
| 3000 | 35.66 | 35.70 | 35.57 | 35.52 | 37.01 |

Note:
Heat aging replication underway on these samples.

### 4) Mechanical and Electrical Characteristics of the Precoat Blend:

As shown in Table 4 below, there is a direct correlation between the level of the PE-wax in the blend to elongation and electrical properties. The data shows that the higher the concentration of the wax, the lower the elongation or ability of the polymer to create a “tail”. Additionally, one can see that electrical properties of the PE wax, based on the dissipation factor, should not negatively impact the attenuation of the cable products given that the dissipation factor of the PE Wax is only marginally higher than straight LDPE (which normally has a dissipation factor around 100−130×10−6 radians). The overall dissipation factor of the blended precoat is affected both by the addition of the NA270 carrier at 60% loading and the NA270/wax component at 40% loading. The displacement of the BTA component is the driving factor behind this improvement in electrical properties.

TABLE 4
Summary of Mechanical and Electrical Performance of the Precoat
Components.

| | NA594 | | | |
|---|---|---|---|---|
| Material Property | Control | 60/40 Blend | Master batch | PE Wax |
| Tensile (PSI) | 1048 | 1045 | N/A | * |
| Elongation (%) | 136% | 69 | N/A | * |
| DF @ 1 MHz | 693 | 752 | 175 | 190 |
| (Radians) | | | | |
| Dielectric Constant | 2.25/2.18 | 2.27/2.22 | 2.22/2.17 | 2.28/2.24 |

N/A = Not valid for comparison in actual target use.
*Not measurable Process Characteristics

All trial product passed the initial water penetration and air leak test requirements. No significant adjustments in process conditions were required to process the wax modified compounds with the only noted change being a 17% reduction in the head pressure following the introduction of the 60140 blend. Table 5 provides a summary of the precoat extruder setting and readings during the trial.

TABLE 5
Summary of Precoat Extruder/Line Conditions

| Precoat | | | Control/Non |
|---|---|---|---|
| tools: | 60/40 Blend | | Wax Modified |
| Die | 0.044″ | | 0.044″ |
| Tip | 0.049″ | | 0.049″ |
| Parameter | Set-point | Actual | Actual |
| Melt | | N/A | N/A |
| Die Retainer | | 326° F. | 326° F. |
| Extruder | | 95.1 | 93.7 |
| RPMs | | | |
| Extruder | | 2.2 | 2.8-3 |
| Amps | | | |
| 1 | 270° F. | 275° F. | 275° F. |
| 2 | 350° F. | 350° F. | 350° F. |
| Clamp Ring | 400° F. | 400° F. | 400° F. |
| Head | 400° F. | 400° F. | 400° F. |
| Pressure | | 3450-3550 psi | 4110-4259 psi |
| Reheater | 850° F. | 850° F. | 850° F. |

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A coaxial cable comprising:
an inner conductor;
a dielectric layer surrounding the inner conductor;
an outer conductor surrounding the dielectric layer; and
a precoat layer disposed between the inner conductor and the dielectric layer, wherein the precoat layer comprises a blend of polymeric material and polymeric wax.

2. The coaxial cable of claim 1, wherein the precoat layer comprises a blend of low density polyethylene (LDPE) and polyethylene (PE) wax.

3. The coaxial cable of claim 1, wherein the PE wax constitutes less than or equal to about 15% by weight of the blend.

4. The coaxial cable of claim 1, wherein the PE wax constitutes less than or equal to about 10% by weight of the blend.

5. The coaxial cable of claim 1, wherein the PE wax constitutes between about 2% and 10% by weight of the blend.

6. The coaxial cable of claim 1, wherein the precoat layer has a thickness of from 0.0001 to 0.020 inch.

7. The coaxial cable of claim 1, wherein the polymeric wax reduces the adhesiveness of the precoat layer between about 10% and 30%.

8. The coaxial cable of claim 1, wherein the precoat layer additionally includes one or more of filler materials and/or anti-corrosion additives.

9. A coaxial cable comprising:
an inner conductor;
a dielectric layer surrounding the inner conductor;
an outer conductor surrounding the dielectric layer; and
a precoat layer disposed between the inner conductor and the dielectric layer, the precoat layer adhesively bonded to the inner conductor and to the dielectric layer, wherein the precoat layer comprises a blend of low density polyethylene (LDPE) and polyethylene (PE) wax, wherein the PE wax constitutes less than or equal to about 15% by weight of the blend, and wherein the adhesive strength of the precoat layer is reduced such that the precoat layer is removed completely and cleanly from the inner conductor as a result of shear forces applied to the precoat layer by a standard commercially available coaxial cable stripping tool.

10. The coaxial cable of claim 9, wherein the PE wax constitutes less than or equal to about 10% by weight of the blend.

11. The coaxial cable of claim 9, wherein the PE wax constitutes between about 2% and 10% by weight of the blend.

12. The coaxial cable of claim 9, wherein the precoat layer has a thickness of from 0.0001 to 0.020 inch.

13. The coaxial cable of claim 9, wherein the polymeric wax reduces the adhesiveness of the precoat layer between about 10% and 30%.

14. The coaxial cable of claim 9, wherein the precoat layer additionally includes one or more of filler materials and/or anti-corrosion additives.

15. A method of manufacturing a coaxial cable comprising:
directing a conductor along a predetermined path of travel into and through a preheater and preheating the conductor;
melting in a first extruder a thermoplastic polymer precoat composition comprising a blend of low density polyethylene (LDPE) and polyethylene (PE) wax;
directing the preheated conductor into and through the first extruder and extruding onto the surface of the center conductor a continuous thin coating layer of the molten precoat composition;
allowing the layer of precoat composition to cool and solidify; and
directing the conductor and layer of precoat composition into and through a second extruder and extruding onto the coated conductor a foamable polymer composition, allowing the foamable polymer composition to expand, cool and solidify to form a foam dielectric surrounding the conductor.

16. The method of claim 1, further comprising surrounding the foam dielectric with a metallic sheath forming the outer conductor of the coaxial cable.

17. The method of claim 15, wherein the PE wax constitutes less than or equal to about 15% by weight of the blend.

18. The method of claim 15, wherein the PE wax constitutes less than or equal to about 10% by weight of the blend.

19. The method of claim 15, wherein the PE wax constitutes between about 2% and 10% by weight of the blend.

20. The method of claim 15, wherein the first extruder forms a precoat layer with a thickness of from about 0.0001 to about 0.020 inch.
